(19) United States
(12) Patent Application Publication
(10) Pub. No.: US 2011/0167461 A1
(43) Pub. Date: Jul. 7, 2011

(54) MEDIA REPRODUCTION APPARATUS

(75) Inventors: Yutaka MARUYAMA, Ichikawa-shi (JP); Shigeki Kitani, Sumida-ku (JP)

(73) Assignee: Buffalo Inc., Nagoya-shi (JP)

(21) Appl. No.: 12/983,473

(22) Filed: Jan. 3, 2011

(30) Foreign Application Priority Data
Jan. 7, 2010 (JP) 2010-002136

(51) Int. Cl. H04N 7/18

(52) U.S. Cl. 725/81

(57) ABSTRACT

A media reproduction apparatus 100 comprises a media reproduction unit 106 capable of reproducing media data received by a wireless LAN interface 101 or a wired LAN interface 102; and a protocol converter 105 for performing protocol conversion between the wireless LAN interface 101 and the wired LAN interface 102. If the wireless LAN interface 101 is connected to an wireless LAN access point, and if the wired LAN interface 102 is connected to a wired-LAN-dedicated television set, the protocol converter 105 performs protocol conversion on data communicated between the wireless LAN access point and the wired-LAN-dedicated television set and then relays the data.

### CROSS REFERENCE TO RELATED APPLICATION

This application is based upon and claims the benefit of priority from, the prior Japanese Patent Application No. 2010-002136 filed on Jan. 7, 2010; the entire contents of which are incorporated herein by reference.

### BACKGROUND OF THE INVENTION

1. Field of the Invention

The present invention relates to a media reproduction apparatus for use with a network.

2. Description of the Related Art

With the spread of home networks used in individual houses, media reproduction apparatuses have come to be widely used which are connected to an external network and used to reproduce media data including image data (see, for example, URL: http://buffalo.jp/products/catalog/multimedia/mediaplayer/).

Here, the image data may be still image data or motion image data. Further, the media data may include audio data.

Some of such network-dedicated media reproduction apparatuses are equipped with two LAN interfaces, i.e. a wireless LAN interface and a wired LAN interface, so as to support both the LAN protocols of a wireless LAN and a wired LAN.

In order for users to access the Internet by using display devices such as television sets, display devices designed for the wired LAN have been put into practice. Such a wired-LAN-dedicated display device can receive on-demand broadcasts and the like from the Internet through a wired LAN.

### SUMMARY OF THE INVENTION

Since the wired-LAN-dedicated display device requires bothersome work for LAN cable layout, there is a demand for making the display device operable wirelessly.

However, to make the wired-LAN-dedicated display device operable wirelessly, a user has to additionally install a bridge device for performing protocol conversion between the wired LAN and the wireless LAN (a so-called Ethernet converter), which is a troublesome work to the user.

Thus, the present invention has an objective to provide a media reproduction apparatus capable of making a wired-LAN-dedicated display device operable wirelessly without additionally installing a bridge device for performing protocol conversion between a wired LAN and a wireless LAN.

In order to solve the problems mentioned above, the present invention has the following features. A first feature of the present invention is summarized as a media reproduction apparatus (media reproduction apparatus 100) for reproducing media data including at least image data, the media reproduction apparatus comprising: a wireless LAN interface (wireless LAN interface 101); a wired LAN interface (wired LAN interface 102); a reproduction unit (media reproduction unit 106) for reproducing the media data received through the wireless LAN interface or the wired LAN interface; an output unit (media interface 103) for outputting reproduced media data to a display device (wired-LAN-dedicated television set 40, for example); a protocol converter (protocol converter 105) for protocol conversion between the wireless LAN interface and the wired LAN interface; and a controller (CPU 107) for controlling the reproduction unit and the protocol converter, wherein if the wireless LAN interface is connected to an access point (wireless LAN access point 30), and if the wired LAN interface is connected to the display device, the controller controls the protocol converter so that the protocol converter performs protocol conversion on data communicated between the access point and the display device and then relays the data.

In general, only one of the wireless LAN interface and the wired LAN interface is connected to a LAN, and the other is not connected to the LAN. Accordingly, while the wireless LAN interface is connected to an access point, the wired LAN interface is not used.

In the media reproduction apparatus according to the present invention, the wired LAN interface which is not usually used when the wireless LAN interface is connected to the access point, is connected to the display device, and the protocol converter performs protocol conversion on data communicated between the access point and the display device, and then relays the data.

Thus, the media reproduction apparatus serves also as a bridge device (Ethernet converter). Accordingly, the wired-LAN-dedicated display device can be operated wirelessly without additional installation of a bridge device (Ethernet converter).

A second feature of the present invention is according to the first feature and is summarized in that: if the wired LAN interface is connected to a wired LAN router (wired LAN router 70), the controller controls the reproduction unit so that the reproduction unit reproduces the media data received by the wired LAN interface via the wired LAN router.

According to such a media reproduction apparatus, when the wired LAN interface is connected to a wired LAN router, the reproduction unit is controlled to reproduce the media data received by the wired LAN interface via the wired LAN router. Accordingly, the wired LAN interface can be used as originally intended.

Thus, the wired LAN interface can be used, if required, in the mode of operation according to the first feature or in the mode of operation according to the second feature.

A third feature of the present invention is according to the first feature and is summarized in that: if the wireless LAN interface is connected to the access point and when the wireless LAN interface receives the media data via the access point, the controller controls the reproduction unit so that the reproduction unit reproduces the media data received by the wireless LAN interface via the access point. According to such a media reproduction apparatus, when the wireless LAN interface is connected to the access point, the reproduction unit is controlled to reproduce media data received by the wireless LAN interface via the access point. Accordingly, the wireless LAN interface can be used as originally intended. Note that the wireless LAN interface can be operated either in the mode according to the first feature or in the mode according to the third feature of the present invention.

A fourth feature of the present invention is according to the first feature and is summarized in that the media reproduction apparatus further includes an Ethernet hub or a switching hub (Ethernet hub/switching hub 109).

The media reproduction apparatus described above can provide such advantageous effects as described below.
The reproduction unit can reproduce media data from a device connected to an Ethernet hub or a switching hub.
A device connected to an Ethernet hub or a switching hub can be connected to a router (an access point or a wireless router) via the wireless LAN interface or the wired LAN interface, so that the device can be handled as if it were on a home network.

A fifth feature of the present invention is according to the first feature and is summarized in that: if the wireless LAN interface is connected to the access point, and if the wired LAN interface is connected to the display device, the wireless LAN interface can receive data on the Internet via the access point.

According to such a media reproduction apparatus, through the reception of data on the Internet by the wireless LAN interface, the data on the Internet can be relayed to a display device, which can thereby receive the data on the Internet.

### BRIEF DESCRIPTION OF THE DRAWINGS

FIG. 1 is a block diagram showing the configuration of a media reproduction apparatus according to an embodiment of the present invention.

FIG. 2 is a diagram showing a first example of the overall configuration of a system including the media reproduction apparatus according to the embodiment of the present invention.

FIG. 3 is a diagram showing a second example of the overall configuration of a system including the media reproduction apparatus according to the embodiment of the present invention.

FIG. 4 is a flowchart showing an example of operation of the media reproduction apparatus according to the embodiment of the present invention.

FIG. 5 is a block diagram showing the configuration of a media reproduction apparatus according to a modification of the embodiment of the present invention.

### DESCRIPTION OF EMBODIMENTS

Next, an embodiment of a media reproduction apparatus according to the present invention will be described with reference to the drawings. To put it concretely, (1) the configuration of the media reproduction apparatus, (2) examples of the overall configuration of a system including the media reproduction apparatus, (3) an example of operation of the media reproduction apparatus, (4) the effects of the embodiment, (5) a modification of the embodiment, (6) and other embodiments will be described. Throughout the drawings of the following embodiment, the same or similar parts bear the same or similar reference numerals.

### (1) Configuration of the Media Reproduction Apparatus

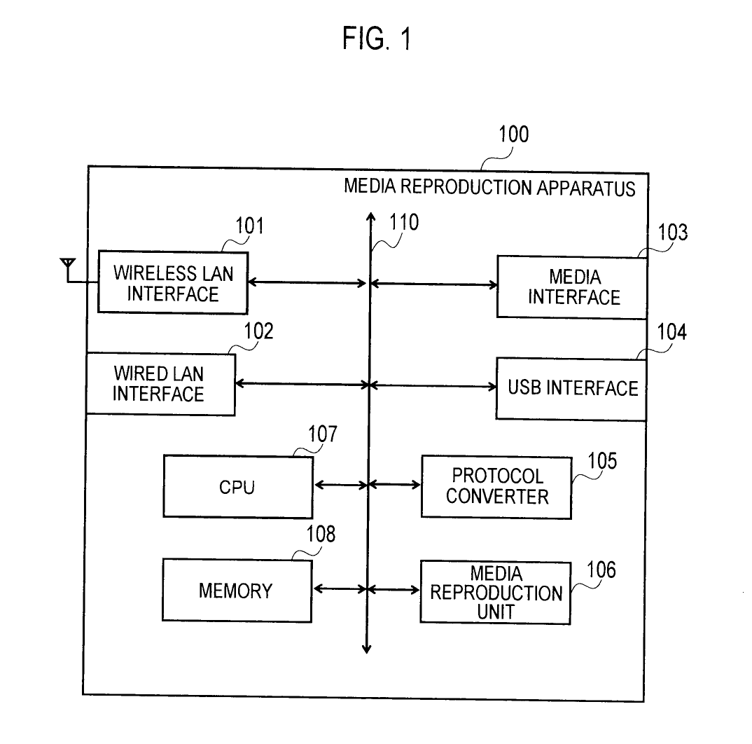

FIG. 1 is a block diagram showing the configuration of a media reproduction apparatus 100 according to the present embodiment. The media reproduction apparatus 100 reproduces media data including at least image data. In this embodiment, the media data include at least one of still image data, motion image data, and audio data.

As FIG. 1 shows, the media reproduction apparatus 100 includes a wireless LAN interface 101, a wired LAN interface 102, a media interface 103, a USB interface 104, a protocol converter 105, a media reproduction unit 106, a CPU 107, and a memory 108.

The wireless LAN interface 101, the wired LAN interface 102, the media interface 103, the USB interface 104, the protocol converter 105, the media reproduction unit 106, the CPU 107, and the memory 108 are connected to one another through a data bus 110.

The wireless LAN interface 101 is used for wireless LAN communication. The wireless LAN mentioned here is, for example, a network compliant with the IEEE802.11a/b/g/n standards. The wireless LAN interface 101 includes an antenna, a radio frequency (RF) unit, a base band (BB) unit, and the like. The wireless LAN interface 101 communicates through a wireless LAN channel.

The wired LAN interface 102 is used for wired LAN communication. The wired LAN mentioned here is, for example, a network compliant with the IEEE802.3/802.3u standards. The wired LAN interface 102 communicates through a LAN cable.

The media interface 103 is used to output media data to a television set or the like. Examples of the media interface 103 include a High-Definition Multimedia Interface (HDMI), an RCA terminal, a D terminal, and the like. The media interface 103 sends out media data through a cable.

The USB interface 104 supports USB specifications such as USB 1.1/2.0/3.0. An external HDD, a USB memory, or the like is connected to the USB interface 104 either directly or through a cable.

The protocol converter 105 performs protocol conversion between the wireless LAN interface 101 and the wired LAN interface 102. In other words, the protocol converter 105 converts the protocol of the data received by the wireless LAN interface 101 into the wired LAN protocol and relays the protocol-converted data to the wired LAN interface 102. In addition, the protocol converter 105 converts the protocol of the data received by the wired LAN interface 102 into the wireless LAN protocol and relays the protocol-converted data to the wireless LAN interface 101.

The media reproduction unit 106 can reproduce media data received by either the wireless LAN interface 101 or the wired LAN interface 102. The media reproduction unit 106 can also reproduce media data received by the USB interface 104.

In the present embodiment, the media reproduction unit 106 reproduces (decodes) motion image data in compliance with, for example, MPEG-1/2/4 and H.264. The media reproduction unit 106 reproduces (decodes) still image data in compliance with, for example, JPEG, BMP, PNG, GIF, or the like. The media reproduction unit 106 reproduces (decodes) audio data in compliance with, for example, AAC-LC, MPEG-1 Layers 1, 2, 3, WMA, or the like.

Media data reproduced by the media reproduction unit 106 is outputted from the media interface 103.

The memory 108 consists of semiconductor memory elements, stores programs to be executed by the CPU 107, and is also used as a work area for the CPU 107. The CPU 107 executes the programs stored in the memory 108, and performs the overall control of the media reproduction apparatus 100. Details of the control by the CPU 107 will be described later. Although not illustrated, a power supply unit and a notification means, such as an LED, are also provided for the media reproduction apparatus 100.

### (2) Examples of the Overall Configuration of a System Including the Media Reproduction Apparatus

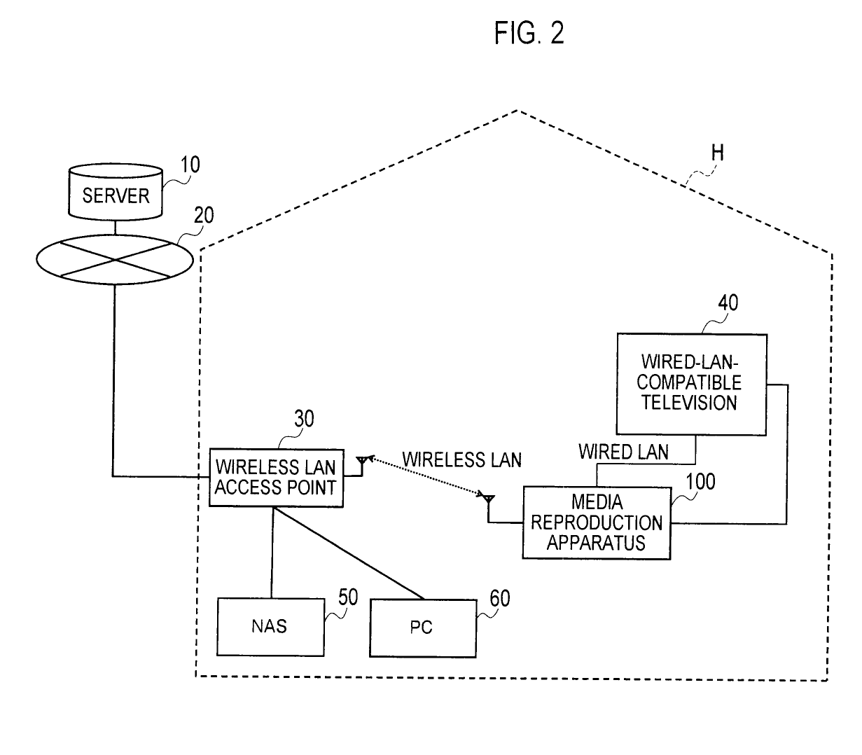

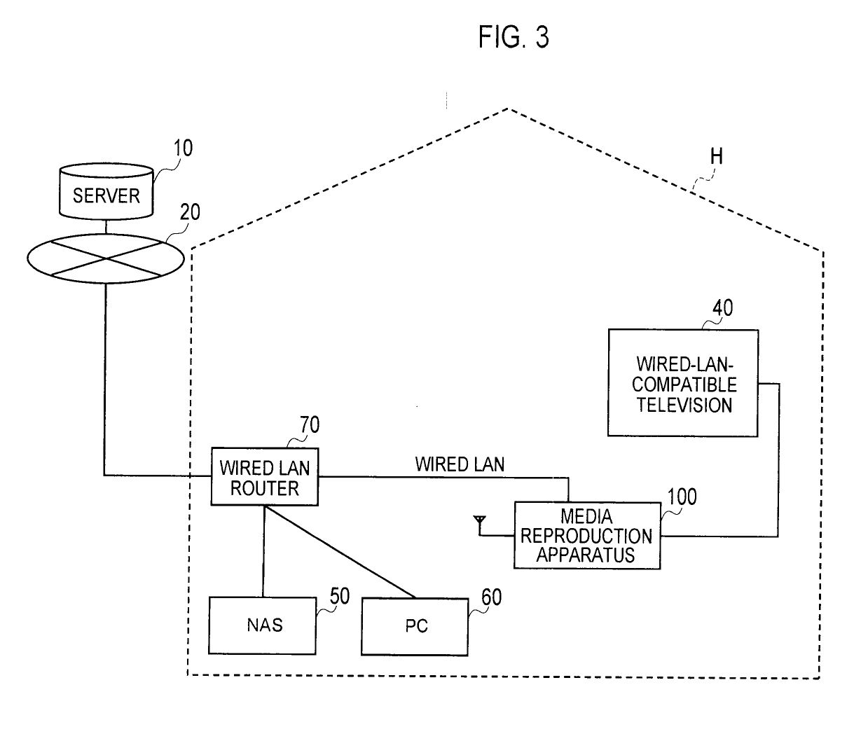

Next, with reference to FIGS. 2 and 3, descriptions are given of examples of the overall configuration of a system including the media reproduction apparatus 100.

(2.1) Example 1 of Overall Configuration

FIG. 2 is a diagram showing Example 1 of the overall configuration of a system including the media reproduction apparatus 100.

In the configuration example 1 shown in FIG. 2, in addition to the media reproduction apparatus 100, a wireless LAN access point 30, a network-attached storage (NAS) 50, a PC 60, and a wired-LAN-dedicated television set 40 are installed in a house H.

The wireless LAN access point 30 is connected to an Internet 20 through a WAN line. The wireless LAN access point 30 communicates with the media reproduction apparatus 100 through a wireless LAN.

The NAS 50 is a network-dedicated storage device for storing media data and the like. The NAS 50 is connected to the wireless LAN access point 30 through a LAN cable.

The PC 60 stores media data and the like. The PC 60 is connected to the wireless LAN access point 30 through a LAN cable.

The wired-LAN-dedicated television set 40 is adapted to a wired LAN, and has the function of receiving contents (e.g., on-demand broadcast), Web data, and the like, delivered by a server 10 on the Internet 20. Here, the wired-LAN-dedicated television set 40 is not adapted to a wireless LAN.

In the configuration example 1, the wireless LAN interface 101 of the media reproduction apparatus 100 communicates with the wireless LAN access point 30 through a wireless LAN channel. In this case, the media reproduction unit 106 reproduces media data received by the wireless LAN interface 101 from the NAS 50 or the PC 60 via the wireless LAN access point 30.

The wired LAN interface 102 of the media reproduction apparatus 100 is connected to the wired-LAN-dedicated television set 40 through a LAN cable. In this case, the protocol converter 105 of the media reproduction apparatus 100 performs protocol conversion on data (Web data) communicated between the wireless LAN access point 30 and the wired-LAN-dedicated television set 40 and then relays the protocol-converted data.

(2.2) Overall Configuration Example 2

FIG. 3 is a diagram showing Example 2 of the overall configuration of a system including the media reproduction apparatus 100. Differences from the configuration example 1 are described here.

In the configuration example 2 shown in FIG. 3, a wired LAN router 70 is installed in place of the wireless LAN access point 30 shown in the configuration example 1. The wired LAN interface 102 of the media reproduction apparatus 100 is connected to the wired LAN router 70 through a LAN cable.

In the configuration example 2, the media reproduction unit 106 reproduces the media data received by the wired LAN interface 102 from the NAS 50 or the PC 60 via the wired LAN router 70.

### (3) Example of Operation of the Media Reproduction Apparatus

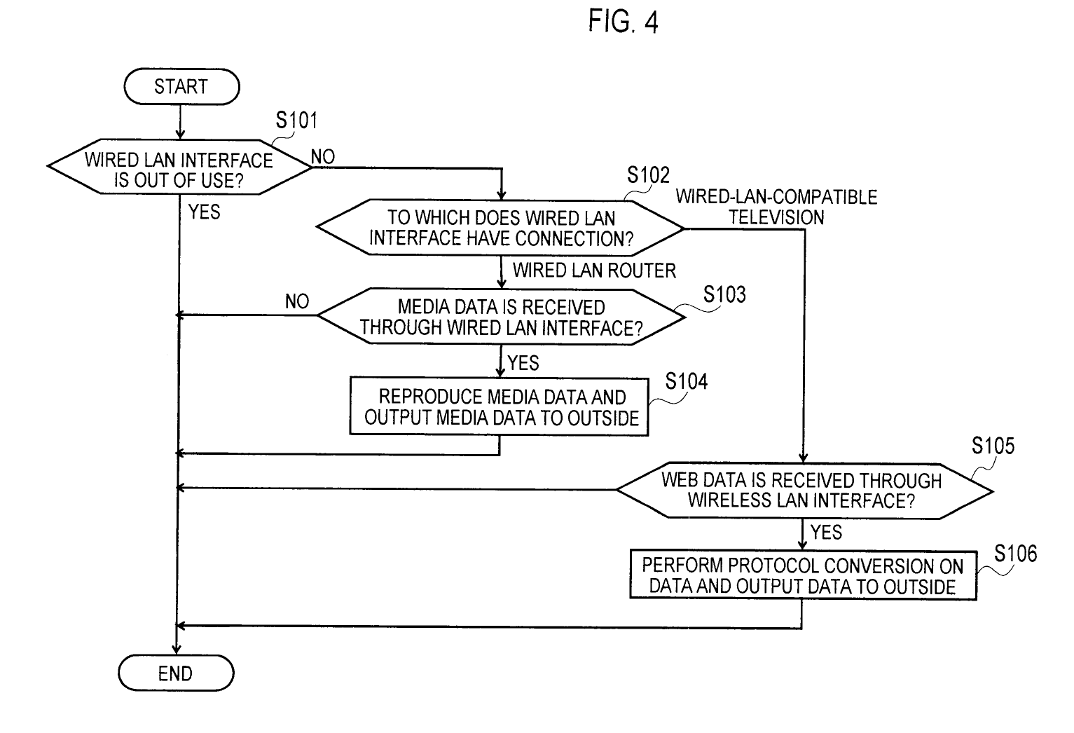

Next, with reference to FIG. 4, an example of the operation of the media reproduction apparatus 100 is described. Here, the operation regarding the wired LAN interface 102 is described. FIG. 4 is a flowchart showing the example of operation of the media reproduction apparatus 100.

If the wired LAN interface 102 is in use (Step S101: NO), connected to the wired LAN router 70, the CPU 107 checks whether or not the media data is received by the wired LAN interface 102 via the wired LAN router 70, in Step S103.

If the media data is received by the wired LAN interface 102 via the wired LAN router 70 (Step S103: YES), the CPU 107 controls the media reproduction unit 106 so that the media reproduction unit 106 reproduces the media data which the wired LAN interface 102 receives via the wired LAN router 70, in Step S104.

The media data reproduced by the media reproduction unit 106 are then outputted from the media interface 103 and inputted to the wired-LAN-dedicated television set 40. The wired-LAN-dedicated television set 40 outputs the media data thus inputted.

On the other hand, if the wired LAN interface 102 is in use (Step S101: NO), connected to the wired-LAN-dedicated set 40, and if the wireless LAN interface 101 is connected to the wireless LAN access point 30, then the CPU 107 checks whether Web data is received by the wireless LAN interface 101 via the wireless LAN access point 30, in Step S106.

If Web data is received by the wireless LAN interface 101 via the wireless LAN access point 30 (Step S105: YES), the CPU 107 controls the protocol converter 105 so that the protocol converter 105 performs protocol conversion on the Web data received by the wireless LAN interface 101 via the wireless LAN access point 30 and then relays the Web data, in Step S106.

The Web data subjected to the protocol conversion in the protocol converter 105 is outputted from the wired LAN interface 102 and inputted to the wired-LAN-dedicated television set 40. The wired-LAN-dedicated set 40 outputs the Web data thus inputted.

Although the operation flow described above is an example of the wireless LAN interface 101 receiving Web data via the wireless LAN access point 30, the Web data may include any type of data as long as they are data on the Internet 20. For example, the following data may be received by the wireless LAN interface 101.
Content data on the Internet 20
Firmware of the media reproduction apparatus 100
Firmware of a device connected to the media reproduction apparatus 100
data necessary for the function provided for the media reproduction apparatus 100, or a device connected to the media reproduction apparatus 100

### (4) Effects of the Embodiment

In the media reproduction apparatus 100 according to the present embodiment, the wired LAN interface 102, which is not normally used when the wireless LAN interface 101 is connected to the wireless LAN access point 30, is used for connection with the wired-LAN-dedicated television set 40, and the protocol converter 105 performs protocol conversion on data communicated between the wireless LAN access point 30 and the wired-LAN-dedicated television set 40, and then relays the data.

With this configuration, the media reproduction apparatus 100 can also function as a bridge device (Ethernet converter). Accordingly, a bridge device (Ethernet converter) need not be additionally installed to make the wired-LAN-dedicated television set 40 operable wirelessly.

Further, in the present embodiment, if the wired LAN interface 102 is connected to the wired LAN router 70, the media reproduction unit 106 reproduces the media data received by the wired LAN interface 102 via the wired LAN router 70. Accordingly, the wired LAN interface 102 can also be used as originally intended.

Further, in the present embodiment, if the wireless LAN interface 101 is connected to the wireless LAN access point 30, the media reproduction unit 106 reproduces the media data received by the wireless LAN interface 101 via the wireless LAN access point 30. Accordingly, the wireless LAN interface 101 can also be used as originally intended.

### (5) Modification of the Embodiment

In the embodiment described above, the media reproduction apparatus 100 includes the wireless LAN interface 101, the wired LAN interface 102, the media interface 103, and the USB interface 104.

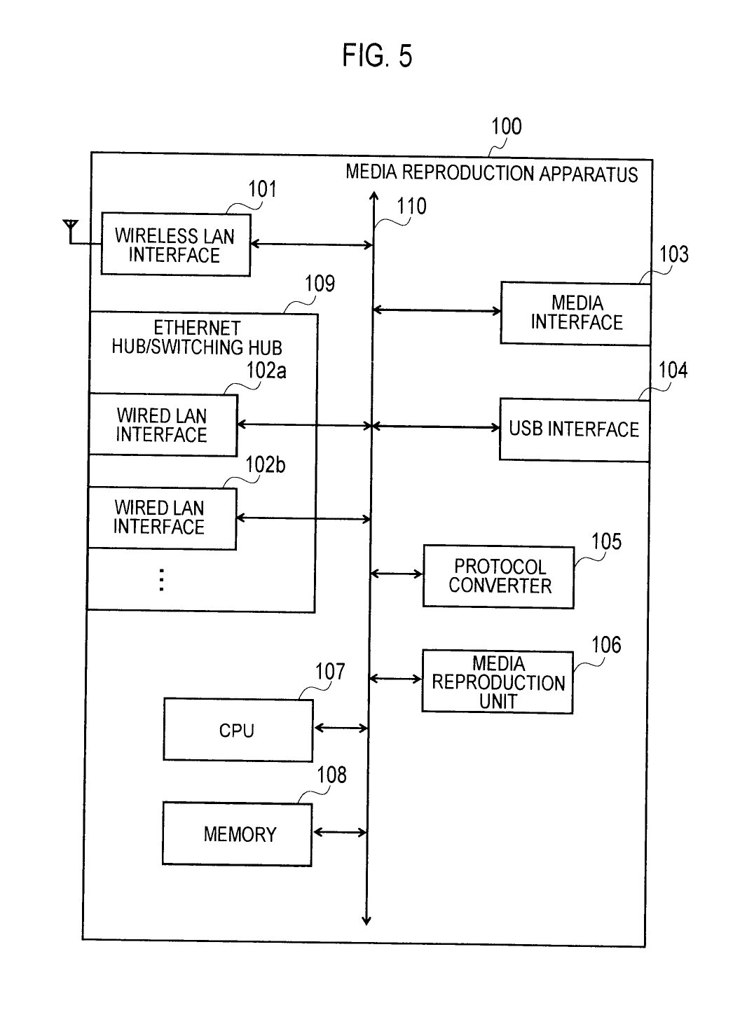

In this modification, as FIG. 5 shows, the media reproduction apparatus 100 includes an Ethernet hub/switching hub 109 in addition to those interfaces. An Ethernet hub is a concentrator having no switching function (a function to interpret MAC addresses and to relay data according thereto). A switching hub is a concentrator having a switching function.

The Ethernet hub/switching hub 109 includes plural Ethernet ports (wired LAN interfaces 102a, 102b, . . . ). These Ethernet ports are connected to Ethernet-dedicated devices. The number of ports of the Ethernet hub/switching hub 109 can be set to 4 to 8, for example. The wired LAN interface 102 according to the above-described embodiment corresponds to one of the plural Ethernet ports.

In the media reproduction apparatus 100 thus configured, the CPU 107 can control the media reproduction unit 106 so that the media reproduction unit 106 reproduces media data from a device connected to the Ethernet hub/switching hub 109.

Further, a device connected to the Ethernet hub/switching hub 109 is connectable to a router (an access point or a wired LAN router) via the wireless LAN interface 101 or the wired LAN interface 102. This allows the device connected to the Ethernet hub/switching hub 109 to be handled as a device on a home network.

In this modification, the wired LAN interface 102 according to the above-described embodiment is described as corresponding to one of the Ethernet ports of the Ethernet hub/switching hub 109. However, the wired LAN interface 102 according to the above-described embodiment and the Ethernet hub/switching hub 109 may be provided separately.

### (6) Other Embodiments

The present invention has been described above through the embodiment, but it should be understood that the present invention is not limited by the descriptions and drawings that constitute a part of the disclosure. This disclosure will make various alternative embodiments, examples, and operational techniques apparent to those skilled in the art.

In the above embodiment, the wired-LAN-dedicated television set 40 is described as an example of the display device. The display device, however, is not limited to the wired-LAN-dedicated television set 40, but may be any display device that supports a wired LAN, and may be, for example, a projector or the like.

In the above embodiment, the media reproduction apparatus 100 has no storage unit other than the memory 108. The media reproduction apparatus 100, however, may be provided with a large-capacity storage unit such as an HDD. In this case, the media reproduction apparatus 100 is capable of storing media data in the large-capacity storage unit.

It should be understood that, as just described, the present invention includes various embodiments and the like that are not described herein. Accordingly, the present invention is to be limited only by the scope of the attached claims.

What is claimed is:

1. A media reproduction apparatus for producing media data including at least image data, comprising:
a wireless LAN interface;
a wired LAN interface;
a reproduction unit capable of reproducing the media data received by the wireless LAN interface or the wired LAN interface;
an output unit for outputting reproduced media data to a display device;
a protocol converter for performing protocol conversion between the wireless LAN interface and the wired LAN interface; and
a controller for controlling the reproduction unit and the protocol converter, wherein
if the wireless LAN interface is connected to an access point, and if the wired LAN interface is connected to the display device, the controller controls the protocol converter so that the protocol converter performs protocol conversion on data communicated between the access point and the display device and then relays the data.

2. The media reproduction apparatus according to claim 1, wherein if the wired LAN interface is connected to a wired LAN router, the controller controls the reproduction unit so that the reproduction unit reproduces the media data which the wired LAN interface receives via the wired LAN router.

3. The media reproduction apparatus according to claim 1, wherein if the wireless LAN interface is connected to the access point and when the wireless LAN interface receives the media data via the access point, the controller controls the reproduction unit so that the reproduction unit reproduces the media data which the wireless LAN interface receives via the access point.

4. The media reproduction apparatus according to claim 1, further comprising an Ethernet hub or a switching hub.

5. The media reproduction apparatus according to claim 1, wherein if the wireless LAN interface is connected to the access point, and if the wired LAN interface is connected to the display device, the wireless LAN interface receives the data on the Internet via the access point.
